(19) United States
(12) Patent Application Publication
(10) Pub. No.: US 2010/0130634 A1
(43) Pub. Date: May 27, 2010

(54) PRODUCTION OF POLYMERS WITH INHERENT MICROPOROSITY

(75) Inventor: Detlev FRITSCH, Reinbek (DE)

Correspondence Address: MICHAUD-Kinney Group LLP, 306 INDUSTRIAL PARK ROAD, SUITE 206, MIDDLETOWN, CT, 06457, US

(73) Assignee: GKSS-FORSCHUNGSZENTRUM GEESTHACHT GMBH, Geesthacht (DE)

(21) Appl. No.: 12/624,818

(22) Filed: Nov. 24, 2009

(30) Foreign Application Priority Data
Nov. 27, 2008 (EP) 08020590.9

(51) Int. Cl. C08J 9/00

(52) U.S. Cl. 521/189

(57) ABSTRACT

A method for producing polymers with inherent microporosity from a starting composition by means of polycondensation and/or polyether synthesis, is carried out with the use of a micro reaction system in a continuous process.

### CROSS-REFERENCE TO RELATED APPLICATION

This application claims priority of European application serial number EP 08 020 590.9 filed Nov. 27, 2008, which is incorporated herein by reference.

### FIELD OF THE INVENTION

The invention concerns a method for synthesizing or producing polymers with inherent microporosity.

### BACKGROUND

Only a few polymers with very large free volume are known. Polyacetylenes or Teflon copolymers are examples of polymers with a large free volume.

The properties of another, new class of polymers with a large free volume, so-called microporous polymers, were described in multiple publications: WO 2005/012397 A3; Budd, et al., “Polymers of intrinsic microporosity (PIMs): robust, solution-processable, organic nanoporous materials”, Chem. Comm. (2004) 230-231; Budd, et al., “Solution-processed, organophilic membrane derived from a polymer of intrinsic microporosity,” Adv. Mat. 16 (2004) 456; Kricheldorf, et al. “Cyclic and Telechelic Ladder Polymers Derived from Tetrahydroxytetramethylspirobisindane and 1,4-dicyanotetrafluorobenzene”, J. Polym. Sci. Pol. Chem. 44 (2006) 5344-5352. These polymers are generally referred to as “polymers of intrinsic microporosity” (PIMs), i.e., polymers with intrinsic or inherent microporosity.

The aforementioned documents disclose standard syntheses in which dimethyl formamide (DMF), N-methyl pyrrolidone (NMP), dimethyl sulfoxide (DMSO) or sulfolane is used as a solvent at a temperature from 60 to 70° C. over a period for the synthesis of 24 to 72 hours. The reaction diagram can be represented as follows:

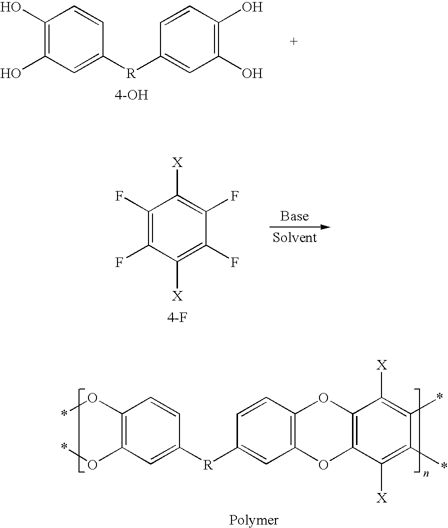

A potassium salt intermediate is formed from the tetrahydroxy compound (4-OH) (e.g., spirobisindan) by the solid base K₂CO₃, which leads to 1,4-dioxane ring closure with the tetrafluoro (4-F) compound. As the polymerization proceeds, rigid ladder polymers are generated with high free volumes, according to the choice of the tetrahydroxy compound.

Moreover, the use of solvents such as N-methyl pyrrolidone (NMP), dimethyl sulfoxide (DMSO) or sulfolane under standard conditions (Kricheldorf, et al., “Cyclic and Telechelic Ladder Polymers Derived from Tetrahydroxytetramethylspirobisindane and 1,4-dicyanotetrafluorobenzene”, J. Polym. Sci. Pol. Chem. 44 (2006) 5344-5352) leads to polymers which differ little in composition or structure from each other.

Since the polymers precipitate from all solvents during the synthesis, the molar masses are automatically limited or the polymerization will continue on the precipitated solid, but at a much slower pace.

Higher temperatures during the synthesis under standard conditions do not lead to higher molecular masses, but they do lead to side reactions such as branching or crosslinking and thus to no improvement in the product. Other monomers, which due to steric considerations should increase the chain stiffness, precipitate from the polymerization solution at low molar masses and do not lead to film-forming polymers, so they are difficult to use.

In the standard synthesis the reaction is strongly exothermic, so it is recommended to stir first at room temperature for a predetermined time to prevent an explosive progression.

Furthermore, the standard synthesis has a very long reaction time and leads to polymers which, for some applications, must be cleaned, thus adding effort and expense to the process. Along with the long reaction time of 2 to 3 days, the (standard) synthesis also produces additional low molecular weight as well as cyclic components which must be removed for the relevant applications with considerable time effort and expense.

Moreover, N. Du, et al., Macromol. Rapid Commun. 2008, 29, 783-788 describes a method in which dimethyl acetamide (DMAC) is used as a solvent at a much higher temperature of 155° C. After about two minutes, the viscosity increases greatly and the resultant polymer begins to precipitate.

The precipitation is hindered by the addition of toluene in two portions after two minutes and four minutes, and the viscosity of the reaction solution is reduced by the dilution. After 8 to 11 minutes altogether at approximately 155° C., the reaction is interrupted by combining the reaction solution with methanol. This gives very high molecular masses with significantly lower polydispersity, which result in mechanical properties which are comparable to the properties achieved via the standard synthesis.

The total reaction time required of 2 to 3 days is shortened by this method to about 10 minutes, with the polymers obtained having reduced low molecular weight portions and sufficiently high molecular mass to form a film.

Furthermore, post-cleaning the product is generally not necessary. This synthesis can be performed with small quantities in the laboratory and has not been scaled up, since in greater dimensions the specified temperatures cannot easily be achieved in the short times, and with larger quantities of reactants the polymerization cannot easily be ended abruptly.

Consequently this procedure from N. Du et al. has not been performed for large scale batches. Moreover, there is the risk in large scale batches that the strongly exothermic reaction cannot be controlled.

### SUMMARY

The present invention resides in one aspect in a method for producing polymers with inherent microporosity. The method includes carrying out a polycondensation reaction in a micro reaction system as a continuous process to produce a reaction product comprising a polymer with inherent microporosity.

In another aspect, the invention relates to a method for producing polymers with inherent microporosity, the method including carrying out a polyether synthesis reaction in a micro reaction system as a continuous process to produce a reaction product comprising a polymer with inherent microporosity.

The present invention resides in yet another aspect in producing polymers with intrinsic microporosity in a simple, optionally continuous manner, using an apparatus which is suited to produce both smaller quantities of polymers with intrinsic microporosity, such as from 1 g (gram) to 10 g, as well as larger quantities of some tens of kilograms per day to some hundreds of kilograms per day. In particular embodiments, the intrinsically microporous polymers (PIMs) obtained as described herein are produced with greater purity than PIMs obtained otherwise.

### BRIEF DESCRIPTION OF THE DRAWINGS

FIG. 1 is a schematic depiction of a micro reaction system for the synthesis of polymers with inherent microporosity according to a first embodiment.

FIG. 2 is a schematic depiction of a micro reaction system for the synthesis of polymers with inherent microporosity according to a second embodiment.

In the figures, the same or similar types of elements or corresponding parts are provided with the same reference numbers in order to avoid the need for redundant presentation.

### DETAILED DESCRIPTION

Various characteristics of the invention are apparent from the description herein together with the appended claims and the Figure included herewith. Inventive embodiments can meet individual characteristics or a combination of multiple characteristics. The invention is described in more detail in the Examples below, without restricting the general intent of the invention. Reference may be made to the drawings with regard to the disclosure of all details of the invention that are not explained in greater detail in the text.

In one embodiment, a reaction product comprising a polymer with inherent microporosity is produced from a reaction solution by means of polycondensation reaction carried out using a micro reaction system. The polycondensation may include a polyether synthesis reaction, but the invention is not limited in this regard, and in other embodiments other polycondensation reactions may be carried out. In various embodiments, the polycondensation and or polyether synthesis is carried out in a continuous process. The micro reaction system may include a micro reactor and, optionally, other devices used in micro process engineering, such as a micro mixer.

In particular embodiments, reaction products comprising ladder polymers with cyclic 1,4-polyethers are produced from monomers by ring closure as part of a polycondensation reaction taking place in a microreactor and/or in another portion of a micro reaction system, optionally as part of a polyether synthesis.

In some embodiments the reaction product includes polymers with intrinsic or inherent microporosity with a low polydispersity and substantially without cyclic polymer portions and/or oligomer portions. The polymers thus obtained have sufficiently high molar masses so that the polymers are able to form films by entanglement. Through the use of one or more microreactors in the micro reaction system it is possible to produce polymers with intrinsic microporosity in small quantities, for example from 1 g (gram) to 10 g, as well as on a large scale of several hundred kilograms per day.

The polycondensation and/or polyether synthesis in the microreactor is distinguished in that it is exothermic and leads to high molecular weight polymers unusually quickly for a polycondensation, e.g., in less than 10 minutes, preferably less than 1 or 2 or 3 or 4 or 5 minutes. Furthermore, in one embodiment, the polycondensation reaction is not reversible due to the high energy stabilization of the resultant six-membered ring.

In a particular embodiment, dissolved reactants are brought to a predetermined and/or desired temperature in less than 1 minute, optionally, in less than 30 seconds. Optionally the reactants are mixed together in less than 1 minute, e.g., in less than 30 seconds, at the reaction temperature, to form a reaction solution. The reaction solution may be formed in a micro mixer, in a micro process engineering embodiment.

The mixing times in a micro mixer and the reaction times in a microreactor may be about 0.01 seconds to about 10 seconds, e.g., about 0.05 to about 5 seconds or, in a particular embodiment, about 0.1 to about 0.5 seconds.

A microreactor is a technical apparatus for a micro reaction system which has a process volume and/or internal volume of about 0.5 ml (milliliters) to about 25 ml, e.g., about 0.5 ml to about 15 ml. Here the process volume is the active tempered capacity in the microreactor. The microreactor can be constructed in a variable manner according to the desired and/or predetermined reaction time. Moreover, a micro mixer may have an internal volume of 0.5 ml, for example, but the invention is not limited in this regard, and in other embodiments, a micro mixer may have a greater or lesser internal volume, as needed.

In various embodiments, the polycondensation reaction is carried out as a continuous process. For example, in one embodiment, the reaction solution in the microreactor is mixed substantially continuously during the reaction and/or polycondensation, in particular during a polyether synthesis.

In another embodiment, the reaction solution is continuously provided to the reaction volume of the microreactor. For example, a cascade reactor from Ehrfeld Mikrotechnik BTS GmbH with the part number 0216 has a process volume of 0.06 ml or 0.15 ml. This cascade reactor is preferably used for liquid/liquid reactions as well as particle suspensions.

In a particular embodiment, a reaction product is obtained at an outlet of the microreactor apparatus by precipitating the reaction product in a precipitation medium. In this manner, the reaction product is obtained from the reaction mixture and/or the reaction product is isolated as required. In one embodiment, the precipitation medium is a temperature-controlled precipitation medium.

Optionally, in one or more further process steps, the precipitated reaction product is filtered and/or dried.

In various embodiments, a starting composition is provided which includes a mixture of reactants which include tetrahydroxy (4-OH) compounds, tetrafluoro (4-F) compounds, or a combination of at least one tetrahydroxy compound and at least one tetrafluoro compound. The mixture of reactants may be prepared at a predetermined reaction temperature. In one embodiment, the preparation of the mixture takes place here in a micro mixer within a few milliseconds.

In another embodiment, the at least one tetrahydroxy compound and the at least one tetrafluoro compound are mixed together in solution as reactants in a mixer, especially in a mixer of micro process engineering (i.e., a “micro mixer”), to form a starting composition (i.e., a starting material and/or starting fluid) which is added to the microreactor for the polycondensation reaction.

In another embodiment, a base is optionally added to the starting composition present as a fluid, in a micro mixer, to provide a reaction solution. The base may be in solution or in suspension. Adding the base initiates the polycondensation reaction in the reaction solution in the micro mixer, which is introduced to the microreactor thereafter.

In various embodiments, the dwell time in the microreactor at a reaction temperature may be 3 to 120 minutes, depending on the monomers, bases and desired molar masses.

In an illustrative embodiment, an excess of K₂CO₃ is used as a base for a polyether synthesis. This base can be added to the microreactor in suspension with special pumps, which enables a stoichiometric excess to be used. However, the invention is not limited in this regard, and in other embodiments this base can be replaced by one or more strong organic bases which are soluble in the solvents used, which facilitates control of the polymerization and helps the entire polymerization proceed in a homogeneous phase.

In one embodiment for the synthesis or production of polymers with intrinsic microporosity (PIM), an activated tetrafluoro compound (4-F) reacts with a tetrahydroxy compound (4-OH), in order to convert the tetrahydroxy compound (4-OH) to a more reactive salt. Bases comprising alkali metal salts in the form of the carbonates or hydrogen carbonates are particularly well suited for this. In one embodiment, K₂CO₃ is used as the base. Optionally, cesium carbonate can be used with, or in place of, K₂CO₃.

In the course of the reaction, the base reacts with the OH group of the tetrahydroxy compound (4-OH), which may for example be a tetraphenol, forms the corresponding salt, and reacts in this activated form very quickly with the formation of the 1,4-dioxane ring. The polymers with intrinsic microporosity are formed in this manner.

By using a microreactor with appropriately large bore holes and a micro pump, the basic suspension is pumped reliably so that the suspended base is added to the starting composition. Optionally, cesium fluoride (CsF) or other fluorides, e.g., potassium fluoride, can be added to the basic suspension to achieve a catalytic effect.

In various particular embodiments, soluble bases in suspended form are used and continuously introduced to the microreactor.

In some such embodiments, bases can be used which are soluble in dimethyl formamide (DMF), dimethyl acetamide (DMAC), N-methyl-2-pyrrolidone (NMP), dimethyl sulfoxide (DMSO) or other solvents typically used for the synthesis of polyethers. Salts of alcohols, particularly lithium, sodium and potassium salts such as potassium t-butylate, sodium methylate, etc. are useful as bases in such embodiments.

In another embodiment, one or more strongly basic nitrogen compounds can be used for catalyzing the polycondensation reaction. Such compounds include 2,2,6,6-tetramethylpiperidines, 1,2,2,6,6-pentamethylpiperidines, 4-methoxyl-1,2,2,6,6-pentamethylpiperidines, diisopropylethylamine, tris-[2-(2-methoxyethoxy)ethyl]amine (TDA-1). Optionally, these and/or other organic bases can be used together with inorganic bases.

In various embodiments, various techniques and equipment known to those of ordinary skill in the microreaction art are used for the production of polymers with inherent microporosity.

Fast, efficient mixing, fast temperature regulation (both heating as well as cooling with strongly exothermic reactions) and variably configurable dwell time at constant temperature can be achieved through the use of equipment for microreaction technology (micro mixers, microreactors, etc.) in a micro reaction system.

Furthermore, through modular design of the equipment for microreaction system, optionally on a corresponding base plate, the product quantity can be increased linearly over time so that using the same apparatus or the same equipment design several hundred kilograms per day of polymers with inherent microporosity can typically be produced in this continuous process.

Through the use of micro reaction system, quantities of new polymers can be made by simple variation of the monomers. Copolymers can also be produced accordingly.

Moreover, in a particular embodiment, a dissolved base is added to the starting composition, preferably in a mixer of micro process engineering, to provide a reaction solution.

In another embodiment, a diluent, e.g., a solvent or base solution, is added to the reaction solution. A polyether synthesis or other polycondensation reaction in the reaction solution can be controlled in this manner.

In still another embodiment, the reaction solution is provided by adding a solvent with an organic base to the starting composition.

The solvent may be a high boiling, polar aprotic solvent, in particular dimethyl acetamide (DMAC) or dimethyl formamide (DMF) or dimethyl sulfoxide (DMSO) or N,N,N,N-tetramethyl urea or sulfolane. In other embodiments, aromatic solvents, including those which have a boiling point above the reaction temperature, may be used.

The flow of the reaction solution in the micro reaction system and/or the dwell time of the reaction solution in the microreactor may be set and/or regulated so that after passing through the microreactor, polymers with inherent microporosity are contained in the reaction solution as a reaction product at the outlet of the microreactor.

In selected embodiments, the synthesis of the polymers with intrinsic microporosity (PIM) as described herein is cost-efficient and can furthermore be performed in a scale of some hundreds of kilograms per day without the end product obtained (PIM) being contaminated with significant amounts of low molecular weight portions and/or macrocyclic products.

The polycondensation and/or polyether synthesis described herein is particularly well suited for a synthesis in the continuous microreactor due to the fast running, strongly exothermic reaction.

Some polymers with intrinsic microporosity produced as described herein have been seen to have a (BET) surface area of at least 200 m²/g (square meters per gram), in some cases at least 500 m²/g. Polymers with intrinsic microporosity and a specific (BET) surface area of at least about 700 m²/g are referred to as polymers with a very large free volume. In one embodiment, polymers with intrinsic microporosity produced as described herein have a BET surface area of about 700 m²/g to about 1600 m²/g.

A further property of some of the polymers with intrinsic microporosity produced as described herein (i.e., some reaction products) is that they have an average pore diameter of less than 100 nm (nanometers), e.g., less than 20 nm, i.e., the reaction products are microporous. In selected embodiments, reaction products have an average pore diameter of about 0.2 to about 20 nm.

As described herein, a micro reaction system can be used to carry out a polycondensation reaction to obtain polymers with inherent microporosity. The polycondensation reaction may be carried out in a continuous manner and may be a polyether synthesis. The use of a micro reaction system as described herein is an example of micro process engineering.

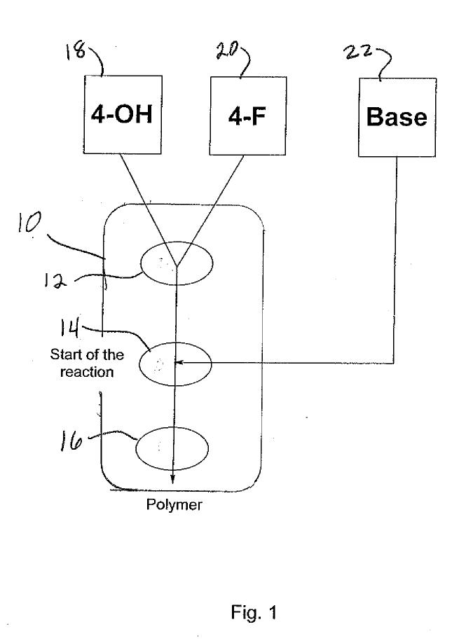

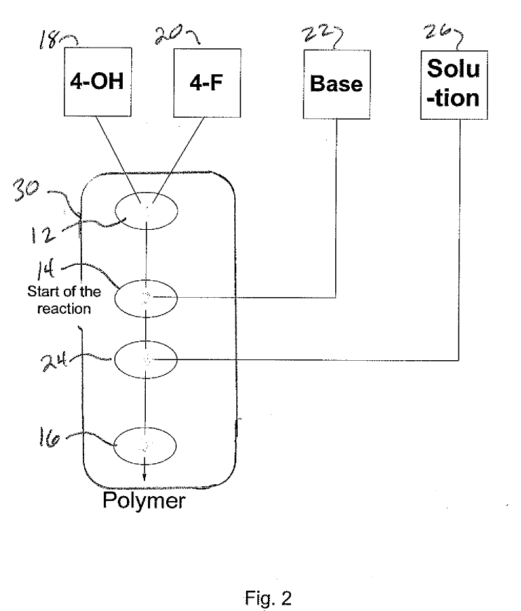

Two illustrative embodiments of micro reaction systems for the synthesis of polymers with inherent microporosity using a microreactor are shown schematically in FIG. 1 and FIG. 2.

A first micro reaction system indicated at 10 in FIG. 1 includes a first micro mixer 12, a second micro mixer 14 and a microreactor 16. Tetrahydroxy compounds (4-OH) 18 and tetrafluoro compounds (4-F) 20 are taken as reactants or components from respective reserves (not shown) and are deposited into the first micro mixer 12 where they are mixed to form a starting fluid and at the same time brought to a predetermined reaction temperature within seconds.

The starting fluid in the first micro mixer 12 is added to a second micro mixer 14 to which a base 22 from a further reserve (not shown) is also added, to provide a reaction solution. The addition of the base starts the polycondensation reaction, e.g., polyether synthesis reaction, in the second micro mixer 14.

The reaction solution is then conveyed or pumped from the second micro mixer 14 to the microreactor 16. In the microreactor 16, the dwell time for the reaction solution and thus the reaction time for the polymerization are determined by the set flow and the length of the microreactor 16.

At the outlet of microreactor 16, the reaction product from the polycondensation of the reaction solution in microreactor 16 is added to a stirred, temperature-controlled precipitation medium (not shown). This stops the polymerization and/or polyether synthesis, and the precipitated (intermediate) product is separated by filtration and dried.

A second micro reaction system indicated at 30 in FIG. 2 comprises the same structures as the first a micro reaction system 10, but also includes a third micro mixer 24 for use after the second micro mixer 14 and before the microreactor 16. In use, the tetrahydroxy compounds (4-OH) 18 and tetrafluoro compounds (4-F) 20 are added to the first micro first micro mixer 12 where they are mixed to form a starting fluid and at the same time brought to a predetermined reaction temperature. The starting fluid in the first micro mixer 12 is added to the second micro mixer 14, to which a base 22 is also added, to provide a reaction solution. The reaction solution is added to a third micro mixer 24, where a diluent 26 (which may comprise pure solvent or additional, dissolved base from a separate reserve(not shown)) is also added to the reaction solution to dilute the reaction solution and alleviate, inhibit or avoid the clogging of the microreactor 16 which may result from an excessive increase in viscosity. The diluted reaction solution is then added to the microreactor 16.

According to the embodiment in FIG. 2, a defined dwell time of the reaction solution is set in the microreactor 16 operated with continuous flow-through, in order to obtain the required degree of polymerization. The microreactor 16 can also have a pressure valve (not shown) to hold lower-boiling solvents such as toluene or xylene in the liquid phase. Alternatively, aromatic solvents such as kerosene, diethyl benzene. etc., which have a boiling point above the reaction temperature, can also be used.

Solvents suitable for the reaction in the microreactor 16 include high boiling point, polar aprotic solvents such as dimethyl acetamide (DMAC), dimethyl formamide (DMF), dimethyl sulfoxide (DMSO), N,N,N,N-tetramethyl urea, sulfolane etc.

The microreactor 16 can be operated at pressures up to 20 bar.

In other embodiments, a single micro mixer 12 can be used if the components tetrahydroxy compounds (4-OH) and tetrafluoro compounds (4-F) are mixed together without the base before they are added to the single micro mixer 12. This is possible because the polycondensation reaction can take place only once the base is added. This way, for example, at least one micro mixer 14 is eliminated, which simplifies the design of the micro reaction apparatus 10.

Three experiments are presented below in which a method described herein was used and the polycondensation and/or polyether synthesis took place in microreactors.

### EXAMPLE 1

A solution containing 10.213 g (30 mmol (millimole)) 5,5′,6,6′-tetrahydroxy-3,3,3′,3′-tetramethyl-1,1′-spirobisindane (4-OH) and 5.252 g (26.25 mmol) tetrafluoroterephthalic acid dinitrile (4-F) was prepared in a volumetric flask, which was then filled to the 50.0 ml mark with dimethyl acetamide. This solution (Solution A) contains 0.60 mmol/ml of 4-OH components and 0.525 mol/ml of 4-F components.

Separately, 2,2,6,6-tetramethyl piperidine is placed in the volumetric flask, which was filled to the 50.0 ml mark with dry xylene to make Solution B with a concentration of 1.32 mmol/ml. Solution A and Solution B were degassed with argon to prevent oxidation.

Both degassed solutions A and B were pumped over a path with pressure sensors using a syringe pump to detect a possible increase in viscosity or clogging in the microreactor. Teflon hoses were used up to the inlet of the microreactor.

A microreactor from Ehrfeld Mikrotechnik BTS GmbH was used to perform the synthesis. It consisted of a base plate of A5 size with the required bracing modules, inlets and outlets and seals as accessories.

Solution A was added to an equilibrated cascade reactor at 150° C. At the same time, Solution B was added through a second opening of the reactor. The outlet was connected directly to a sandwich reactor equilibrated to 150° C.

After a dwell time of 75 minutes, no precipitation was observed in methanol. Therefore the outlet of the cascade reactor was connected with a further sandwich reactor. After a total of 15 minutes dwell time in both reactors, a yellow, fluorescent powder was obtained by precipitation in methanol. According to gel permeation chromatography (GPC), the molar mass Mw had a value of approximately 4000 g/mole (grams per mol).

The pumping rate of Solution A was at 0.5 ml/min (milliliters per minute); Solution B was pumped at 1.0 ml/min in order to at least make stoichiometric quantities of base available. Since the added quantity of 4-OH was used in a slight excess with respect to the 4-F component, this approach yielded terminally functional linear polymers or telechelic polymers with —OH end groups.

### EXAMPLE 2

Example 2 was carried out like Example 1, but tris-[2-(2-methoxyethoxy)ethyl]amine was used as a base. Terminally functional linear polymers or telechelic polymers with a molar mass Mw of approximately 4000 g/mole were obtained.

### EXAMPLE 3

7.65 g (12.16 mmol) of silylated 5,5′,6,6′-tetrahydroxy-3,3,3′,3′-tetramethyl-1,1′-spirobisindane (4-OH) (also referred to as 4-OTMS) were dissolved with 2.43 g (12.6 mmol) tetrafluoroterephthalic acid dinitrile (4-F) in dimethyl acetamide to make a 0.60 molar solution of 4-OTMS and 4-F (Solution C). The two monomers were thus used in a stoichiometric ratio of one to one. Tris-[2-(2-methoxyethoxy)ethyl]amine (1.32 M) in a saturated solution of cesium fluoride (CsF) in dimethyl acetamide was used as a base (Solution D).

The apparatus from Example 1 was used, but both reactors were immediately flowed through. Pumping rates of 0.5 ml/min for Solution C and 1.0 ml/min for Solution D were set in order to make at least stoichiometric quantities of base available. This corresponds to a 10% excess of base.

A gaseous development at the reactor outlet showed that the reaction of the 4-OTMS monomer forms a gaseous silylated side product. After 15 minutes, both reactors were filled with the flow of reaction solution, and the polymer precipitated at the reactor outlet showed a molar mass of approximately 19,000 g/mol by gel permeation chromatography (GPC).

Since a precipitate was observed in the Teflon hose at the reactor outlet, dry xylene was added with a pumping rate of 0.5 ml/min via a micro mixer after the outlet of the first reactor. This lowered the molar mass Mw to 11,000 g/mol, but the precipitate was slowly dissolved.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for producing polymers with inherent microporosity, comprising:
carrying out a polycondensation reaction in a micro reaction system as a continuous process to produce a reaction product comprising a polymer with inherent microporosity.

2. A method according to claim 1, wherein the polycondensation reaction comprises a polyether synthesis reaction.

3. A method according to claim 1, wherein the micro reaction system includes a microreactor having an outlet, and comprising precipitating the reaction product from the polycondensation in a precipitation medium at the outlet.

4. A method according to claim 3, including filtering and/or drying the reaction product.

5. A method according to claim 1, comprising providing a starting composition which comprises a mixture of at least one tetrahydroxy containing compound and at least one tetrafluoro containing compound.

6. A method according to claim 5, wherein the micro reaction system includes a micro mixer and the method includes mixing the at least one tetrahydroxy containing compound and the at least one tetrafluoro containing compound in the micro mixer.

7. A method according to claim 5, comprising adding a suspended base to the starting composition to provide a reaction solution.

8. A method according to claim 7, comprising adding a dissolved base to the starting composition.

9. A method according to claim 5, comprising adding a dissolved base to the starting composition.

10. A method according to claim 7, comprising adding a solvent to the reaction solution.

11. A method according to claim 9, comprising adding a solvent to the reaction solution.

12. A method according to claim 7, comprising adding a solvent with an organic base to the reaction solution.

13. A method according to claim 9, comprising adding a solvent with an organic base to the reaction solution.

14. A method according to claim 9, wherein the solvent includes one or more of a polar aprotic solvent, dimethyl acetamide (DMAC), dimethyl formamide (DMF), dimethyl sulfoxide (DMSO), N,N,N,N-tetramethyl urea, or sulfolane.

15. The method of claim 1, wherein the polycondensation reaction comprises a polyether synthesis reaction.

16. The method of claim 1 wherein the reaction product comprises a ladder polymer.

17. The method of claim 1 wherein the polycondensation reaction produces a 1,4-dioxane ring in the reaction product.

18. A method for producing polymers with inherent microporosity, comprising:
carrying out a polyether synthesis reaction in a micro reaction system as a continuous process to produce a reaction product comprising a polymer with inherent microporosity.

19. The method of claim 18, comprising reacting a tetrahydroxy compound with a tetrafluoro compound to obtain a reaction product comprising a ladder polymer having 1,4-dioxane rings.
